(19) United States
(12) Patent Application Publication
(10) Pub. No.: US 2023/0062774 A1
(43) Pub. Date: Mar. 2, 2023

(54) Accessory Holder for a Paint Can

(71) Applicants: Mandy McCormick, Northbridge, MA (US); Elismar Carolino, Northbridge, MA (US)

(72) Inventors: Mandy McCormick, Northbridge, MA (US); Elismar Carolino, Northbridge, MA (US)

(21) Appl. No.: 17/902,017

(22) Filed: Sep. 2, 2022

Related U.S. Application Data
(60) Provisional application No. 63/240,072, filed on Sep. 2, 2021.

(51) Int. Cl. B44D 3/12

(52) U.S. Cl. CPC B44D 3/123

(57) ABSTRACT

The present invention relates to a tool, such as paint brush storage or holding device. The device is designed to hold a tool or paint brush in an upright position within a can. The storage device is in the shape of an inverted “J” or “L” and is coated with a protective material. The storage device is supported by the rim of a can and attaches to the handle of a paint brush by use of movable gripping arms. The storage device may further comprise one or more additional attachment points to store additional paint brushes or painting accessories on the exterior of a paint can.

### CROSS-REFERENCE TO RELATED APPLICATION

The present application claims priority to, and the benefit of, U.S. Provisional Application No. 63/240,072, which was filed on Sep. 2, 2021, and is incorporated herein by reference in its entirety.

### FIELD OF THE INVENTION

The present invention relates generally to the field of painting accessories. More specifically, the present invention relates to an accessory, such as a paint brush storage or holding device designed to hold a paint brush or other accessory in a preferred configuration or position within the interior of a paint can, and another accessory on the exterior of the can or receptacle. Accordingly, the present disclosure makes specific reference thereto. Nonetheless, it is to be appreciated that aspects of the present invention are also equally applicable to other applications, devices, and methods of manufacture.

### BACKGROUND

Devices, such as clips and hooks, for holding paint brushes are generally desired in the art as they improve workspace organization and can help facilitate and expedite the overall painting or decorating process by eliminating the need to search for a paint brush or another accessory when not in use. Within the painting and decorating industry, one area of concern is increasing the longevity of paint brushes and more particularly the brush bristles. More specifically, paint brush bristles can be easily damaged if the brush is not stored with care when not in use, or if the paint brush is not properly cleaned and cared for after it has been used. While painting on a ladder or in other hard to reach places, there are a multitude of reasons for needing to set a brush down, such as having to move a ladder, add additional masking tape and tarps to protect the areas surrounding that which is being painted, taking a phone call, talking to other workers, or just taking a break.

Unfortunately, when a paint brush is set down in a place where it should not be (e.g., a dirty surface, in the grass, on a finished surface, etc.), the bristles of the paint brush can easily be bent out of shape, particularly if the paint is left to dry on the bristles. Further, the wet paint on the now deformed bristles will harden, and in turn, may ruin the paint brush.

Furthermore, painting on a ladder can be very dangerous. General ladder safety recommends that at least one hand be in contact with the ladder at all times. Trying to maintain control of a paint brush, a paint bucket, other tools, and painting accessories while having at least one hand in contact with the ladder can be very cumbersome if not impossible. Accordingly, a painter should not have to think about finding a place to put his or her paintbrush while up on a ladder. All focus should be on painting and maintaining safe practices. Falling from a ladder can easily result in bodily harm, or even death.

Additionally, painters typically like to bring more than just a paint bucket and a paint brush with them when working on a particular job. They often also bring drip rags that are used to wipe off excess paint from where they are working, as well as tarps or other protective sheeting to protect furniture, floors, and other areas that the painter does not want to splatter with paint, stain, or other material that the individual is using. Therefore, there is often a need to hold or store various painting accessories when not in use, in addition to a paint brush when in use.

Not wasting materials is also very important in any job, and this is also true in the field of painting and decorating. Certain types of paint can be very expensive, and therefore needs to be handled and stored with care. If a wet paint brush is set down haphazardly, the wet paint may drip from the brush and onto the surface beneath it. Also, depending on the angle at which the brush is set down, the paint could even end up on the handle of the brush and then come in contact with the hand of the user. This not only potentially wastes large amounts of paint, but it could also make the handle of the brush less suitable for future use.

Therefore, there exists a long-felt need in the art for a paint brush holder that provides users with a place to temporarily store a paint brush in an upright position in the interior of a paint can when not in use. There is also a long-felt need in the art for a paint accessory support or storage device that holds or suspends brushes in a way that prevents the bristles of the brush from splaying out of alignment, or otherwise becoming bent or damaged. Further, there is a long-felt need in the art for a paint brush holder device that can help painters and other workers be more organized, and maintain safety while painting on a ladder, scaffolding or other work supports. Moreover, there is a long-felt need in the art for a painting accessory that includes at least one additional hook or clip positioned on an exterior surface of a paint can that may accommodate additional paint brushes or painting accessories. Finally, there is a long-felt need in the art for a paint brush storage or supporting device that will reduce the amount of paint or other material that is wasted after the paint brush has been used and that extends the brush outwardly from the holder to reduce the possibility of paint getting on the handle of the brush.

The subject matter claimed and disclosed herein, in one embodiment thereof, comprises an accessory holder for a can in the form of a supporting tool for holding a paint brush or other accessory in a preferred position within the interior of the can so that the force of gravity can be used to allow paint or other material to drip or drain from the accessory back into the can, and eliminate waste. The hook like device has a metal base that may be covered in a thin plastic, rubber, silicone, anti-slip, or an anti-corrosive coating to prevent the device from rusting when exposed to moisture or slipping when mounted on the side of the can or receptacle. Further, the accessory holder may include additional attachment points, clips, or hooks for temporarily storing other accessories or items.

In this manner, the accessory used for storing or holding the painting or decorating accessory of the present invention accomplishes all of the foregoing objectives and provides users with a device that can be used to temporarily store, hold or support paint brushes, other accessories or personal items in a safe and convenient manner. The device allows a user to safely store multiple sizes of paint brushes or other accessories in a way that will not damage the bristles of the accessory. The device will also be able to store accessories such as paint brushes in a way that will allow excess paint or other material to drip or flow back into the can and in turn, minimize waste of the paint or material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an accessory storage device. The invention is a multipurpose clip or tool for temporarily storing a paint brush or another item in an upright position within the interior of a paint can or receptacle to prevent the bristles of the brush from splaying out of their original alignment, and to allow any remaining paint or material on the brush to drip or flow down into the can or other receptacle where it can be reused. The storage device is preferably a hook or clip-like device having an interior and exterior leg, a right-angle bracket along with a clamp, and two arms that extend inwardly off the interior leg. The invention may be constructed from metal, durable plastic, composite, or any other suitable material, and may include an outer layer such as an anti-corrosive, protective, or anti-slip coating. In a further embodiment, the accessory holder may also have an additional clip or hook-like structure, or other attachment point, positioned on the exterior of the can, receptacle, or container for storing additional brushes or other accessories. The clips or hook-like structure may be in the form of a double “L” or “J” hook of be generally “U” shaped.

The present invention provides a safe and convenient way to store one or more paint or decorating brushes and other accessories being used on a job freeing up the hands of the individual for use on other tasks, such as holding onto the ladder, scaffolding, or other support. The tool holder can store multiple and/or different shapes and sizes of brushes and tools as well as other paint applicators, such as paint rollers, pads, and accessories, such as openers, screw drivers, putty knifes, rags and combinations thereof. The clip arms or hooks of the device are flexible and may have a hinge component so that they can be bent inward or outward due to their soft plastic or metal composition. This allows the clip or hook to hold a variety of shapes and sizes of brushes, tools, and other accessories.

In one embodiment, the base component comprises an inverted “J” or “L” shaped configuration that is designed to be removably attached to a rim or edge of a paint can or other material container. Specifically, the base component includes an exterior leg that is generally perpendicular to a centerpiece that helps hold the device on the rim or edge of a paint can or other container. There is an interior leg extending downwardly from the centerpiece that includes two malleable arms that can be bent or adjusted to securely hold different shapes and sizes of paint brushes. The arms may use a memory material so as to recall a particular shape of a brush or accessory that is used repeatedly or alternatively may have a series of pre-set positions which the arms can be moved to accommodate standard size brushes or accessories. The centerpiece is sized and configured to rest or sit on the rim or edge of the paint can or other container while the exterior leg travels downwardly along the exterior surface of the paint can and the clamp extends horizontally outward and generally perpendicular from the interior of the paint can or other container. In this way, the brush or other accessory does not come into contact with the interior surface of the paint can or container which may have paint or other material on the interior surface. The clamp that extends from the centerpiece acts as an anchoring or holding agent that helps secure the handle of the brush or accessory in a way that allows the bristles of the brush to be suspended over the remaining paint or bottom of the can without touching the bottom of the can.

In one embodiment, the base component is sized to accommodate the dimensions of a normal size (one gallon) paint can. A one-gallon paint can is about 7.5 inches tall and has a diameter of around 6.5 inches. The rim of the can is also about 0.5 inches wide. The exterior leg of the invention should have a length of about 1 to 3 inches and the centerpiece should have a length of 0.5 to 1.5 inches to accommodate the width of the paint can rim. The interior leg should be 1 to 2 inches long to accommodate the clamp arms and have enough surface area in direct contact with the rim of the can to create a secure fastening for the brushes or accessories. The center connector should have an adjustable length to accommodate different size paint cans or containers and different fitment requirements of the user. Nonetheless, any other dimensions could be sufficient as known in the art, depending on the preferences of the user or the particular type and size of the can, container, or receptacle that is being used for a particular project. Regardless of the material that the can, container, or receptacle are made of, the invention will still perform its function by being fastened to the rim or top edge of the can, container, or receptacle.

In another embodiment, the opposing interior leg and exterior leg are held together by a middle connecting piece. This connecting piece will have a sliding component that will allow the overall length of the centerpiece to be altered or extended. The sliding component will allow the distance between the interior and exterior legs to be flush with the rim of the can, in turn, creating an adjustable way of anchoring the paint brush or accessory storage device to the can, container, or receptacle. Preferably, the interior leg of the device is shorter than the exterior leg, so the clamp arms are still even with the rim of the can. This keeps the bristles of the brush either partially submerged in a nearly full can or suspended over the paint or other material in an almost empty can and from touching the bottom of the can or container so that the bristles of the brush are not bent or splayed out of position. Either way, the paint brush or other accessory is being stored in a way that keeps the bristles safe and prevents paint from being wasted. Having the bristles hang below the interior leg of the device and below the rim of the center piece keeps the brush closer to the remaining paint. The closer the paint brush is stored to the remaining paint or material in the can when it is not in use, the quicker the brush may be reinserted into the remaining paint to resume the painting or decorating task. Nonetheless, any other suitable securing means could be used to hold the hook in position.

In one embodiment, the hook is capable of holding a variety of paint brush shapes and sizes as well as other tools and accessories. The adjustable and conformable arms extending out from the interior leg of the device can be moved inward or outward to accommodate different shapes and sizes of brushes. The arms can be wrapped around the desired part of the handle to securely hold the tool or brush so that the bristles will not splay out of alignment or get damaged, and the remaining paint on the brush can drip back into the paint can so that it is not wasted.

In another embodiment, the exterior leg of the hook houses another, smaller hook. This hook can be used to help transport or store other painting or related accessories, such as, but not limited to, a drip rag, putty knife, scraper, paint can opener, as well as non-painting accessories such as, a cell phone which may be placed within a holder or pocket and then suspended from the hook.

In yet another embodiment, the paint brush storage device can be manufactured from any number of rigid or semi-rigid materials such as metal or plastic components. The metal components of the device could be manufactured from a large range of metals such as aluminum, stainless steel, galvanized steel, and other composites. The plastic components of the device could be manufactured from plastics or polymers such as, but not limited to, Polyethylene Terephthalate, (PET), High-Density Polyethylene, (HDPE), or Low-Density Polyethylene, (LDPE).

In yet another embodiment, the paint brush storage device may include a plurality of indicia or graphics.

In yet another embodiment, a method of securing a paint brush or other tool or accessory safely in a vertical position in the interior of a paint can or other receptacle when temporarily not in use is described. The method comprises the steps of initially providing a paint brush holder and securing it onto the rim of a can, receptacle, or container using an adjustable sliding component of the connector piece. The method further includes aligning the handle of the paint brush with the adjustable arms that extend from the interior leg of the paint brush storage device and pushing the handle of the brush into the arms so the brush is held between the arms. Next, the arms are adjusted around the paint brush handle so that the brush is stored in a way that will prevent the bristles from being bent or damaged and will permit the remaining paint on the brush to drip back into the can. The arms that hold the brush are preferably manufactured from a flexible plastic such as, but not limited, to Low Density Polyethylene (LDPE), so that the arms are able to bend around the handle of the brush to firmly secure it. Alternatively, the arms may have a memory-based material such as Nitinol wires placed within the arms to allow the arms to return to the same shape as used before. There may be two or more Nitinol wires spaced equally apart. In a still further embodiment, the arms may have a series of pre-sets which lock in position to accommodate standard sized handles of tools.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the paint brush storage device of the present invention being used to temporarily store a paintbrush in a vertical orientation in the interior of a paint can in accordance with the disclosed architecture;

FIG. 2A illustrates a perspective view of various orientations of one potential embodiment of the paint brush, tool or accessory storage device of the present invention in accordance with the disclosed architecture;

FIG. 2B illustrates a top view of alternate features of the arms of one potential embodiment of the accessory holder of the present invention in accordance with the disclosed architecture; and

FIG. 3 illustrates a perspective view of one potential embodiment of the paint brush, tool or accessory storage and holding device of the present invention with a paint brush being secured in the adjustable arms of the invention of the interior leg in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

Therefore, there exists a long-felt need in the art for a hook that provides users with a place to temporarily store a paint brush, tools, and other accessories in an upright position in the interior of a can, container, or receptacle. There is also a long-felt need in the art for a tool storage device that holds the tool, such as a brush, in a way that prevents the working end of the tool, such as bristles of the brush, from splaying out of alignment and from becoming bent or damaged, thereby maintaining the toe or tip of the brush in an original condition. Further, there is a long-felt need in the art for a tool holder that can help painters and other laborers to be more organized in the workplace and in turn, maintain a safe environment while painting on a ladder, scaffolding or other raised support. Moreover, there is a long-felt need in the art for a device that has an additional hook that is positioned on the front or exterior surface of the can to permit the storage of additional accessories. Finally, there is a long-felt need in the art for a tool storage device that will reduce the amount of paint that is wasted after the use of the brush until the brush can be cleaned and put away for storage.

The present invention, in one exemplary embodiment, is a tool or accessory storage device or holder. The invention is a painting, decorating, or other work accessory that is designed specifically to hold tools, such as paint brushes, in an upright position and ready for use by a painter or other individual. The device preferably includes a clip-like device for placement over the rim of a can, container, or other receptacle and two adjustable or moveable arms that are positioned on an interior leg of the device for securing a tool such as a paint brush in a desired orientation on the interior of a can, container, or receptacle. More specifically, the ferrule of the paint brush will manually and removably attach to the adjustable arms of the holder device such that the paint brush is positioned in a generally vertical orientation with the brush bristles slightly above the remaining level of paint or other material in the can, container, or receptacle.

The adjustable arms that extend outward from the interior leg of the tool storage device can hold a variety of shapes and sizes of tools, accessories and paint brushes due to the malleable, moveable or configurable plastic materials that these parts are manufactured from such as, but not limited to, Polyethylene Terephthalate, (PET), High-Density Polyethylene, (HDPE), or Low-Density Polyethylene, (LDPE). In a further embodiment, the holder device further includes a second attachment point on the exterior leg for supporting additional paint brushes, tools, or other painting accessories on an exterior side of the can but in close proximity to the user for easy access. Such painting accessories may include, but are not limited to, a drip rag, putty knife, scraper, paint can opener, as well as non-painting accessories such as, a cell phone which may be placed within a holder or pocket and then suspended from the hook.

A method of securing a paint brush safely in a vertical position for storage is also described herein. The method comprises the steps of initially providing a tool holder having two adjustable arms and installing the tool holder on the rim of a paint can. The method further includes aligning the desired part of the tool handle with the adjustable arms that stem from the interior leg of the device in the interior of the can, and then attaching the desired part of the handle so that it is disposed between the adjustable arms to store the tool in a secure way that will not damage the bristles and that will allow any remaining paint or other material on the brush to drip back down into the base of the can or container. Finally, the tool, such as a paint brush, can be removed from the grip of the adjustable arms by pulling the brush handle towards the gap or opening between the two arms and away from the rim of the paint can.

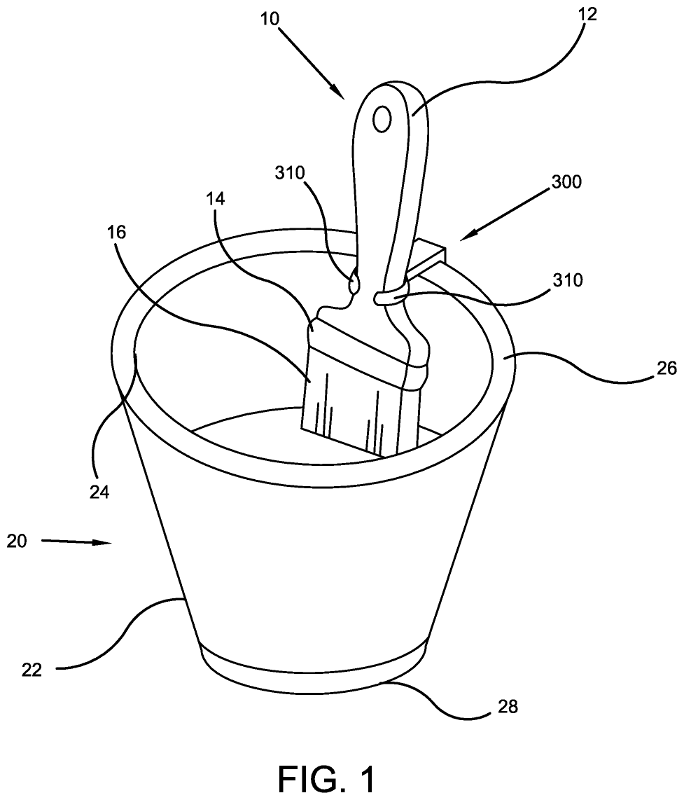

Referring initially to the drawings, FIG. 1 illustrates a perspective view of one embodiment of the tool holder or storage device 300 of the present invention. In the present embodiment, the tool holder or storage device 300 is an improved paint brush storage device that provides users with a place to conveniently store their tool, such as a paint brush, in an upright position. The device 300 is specifically designed to allow any user to store a tool such as a paint brush in a manner that will not bend or damage the bristles 16 of the brush 10 and thus maintain the tip or the toe of the brush in a desired configuration.

More specifically, the device 300 includes an exterior or first leg 360 having a first length, a connector or top portion 330, and an interior or second leg 350 having a length different than that of the first leg 360. The top or connector portion 330 has a third length which is different from either of the first and second legs, and shorter than both of the first and second legs. Both the exterior or first leg 360 and interior or second leg 350 extend perpendicularly downward from the top or rim portion 330 when positioned on the rim of a paint can, and the legs are generally parallel to one another and spaced apart by a distance equal to the third length. The middle connecting piece 330 will house a sliding component 340 that will allow for the length of that centerpiece 330 to be altered to accommodate the dimensions of different can rims 26. The interior or second leg 350 is the leg on the interior surface 24 of the can 20 in which the clamp arms 310 are positioned and the handle 12 of the brush 20 is attached and held by the arms 310. The clamp arms 310 are adjustable so that a variety of shapes and sizes of paint brushes 10 or other tools can be securely fastened by the tool holder or storage device 300 in a way that the work portion, such as the bristles 16 of a brush 10, are directly above the remainder of the paint 40 left in the can 20.

The brush hook 300 is mounted on to a paint can 20 to store a paint brush 10. A conventional paint can 20 has four main parts: a base 28, a can rim 26, an exterior side wall 22, and an interior wall 24. Paint 40 or other spreadable materials, such as a stain, varnish, primer, or the like, is typically stored in the interior of the can, container, or receptacle 20 and is, in turn, spread by the paint brush 10, another tool or applicator. A conventional paint brush 10 has three main parts: a brush handle 12, a metal connector or ferrule 14, and a plurality of bristles 16 extending outward from the ferrule 14 in a direction opposite that of the handle 12 and culminating in a brush tip or toe.

Referring again to FIG. 1, the tool or accessory hook 300 is used to secure a paint brush 10 or other tool or accessory in place. The paint brush 10 is held in place vertically adjacent to the interior wall 22 of the paint can 20, so that the plurality of bristles 16 are facing downward toward the base 28 or remaining paint 40 in the can 20, and the brush handle 12 extends outward from the open end of the can and above the rim for easy retrieval by the user. The tool, accessory, or paint brush 10 is attached to the tool holder 300 by sliding the desired part of the tool handle 12 in between the clamp arms 310 that are on the interior leg 350 of the device 300. The clamp arms 310 preferably extend outward from the interior leg 350 by a distance ranging from 0.10 to 0.25 inch to hold the tool or paint brush in a slightly spaced apart relationship to the surface of the second leg 360 to prevent paint or other material from transferring to the handle of the tool, applicator, or paint brush.

By way of background, most standard one-gallon paint cans 10 have a height of about 7.5 inches and a diameter of about 6.5 inches and, the rim 26 that runs along the top of the paint can 20 usually has a width of about 0.5 inch. Therefore, the brush holder 300 of the present invention should be designed to accommodate these particular dimensions, though it is contemplated that the brush holder 300, particularly the adjustable centerpiece may also be sized and configured to accommodate any other suitable size or shape as it is known in the art, depending on the preferences of the user.

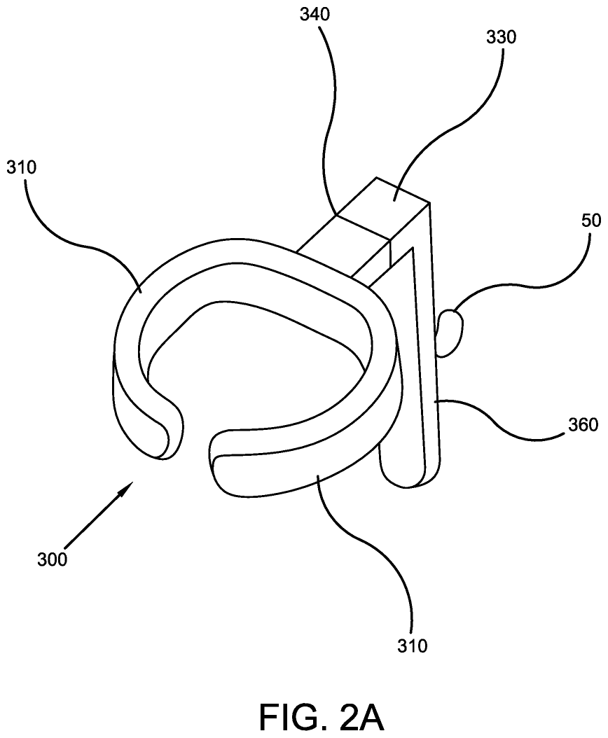

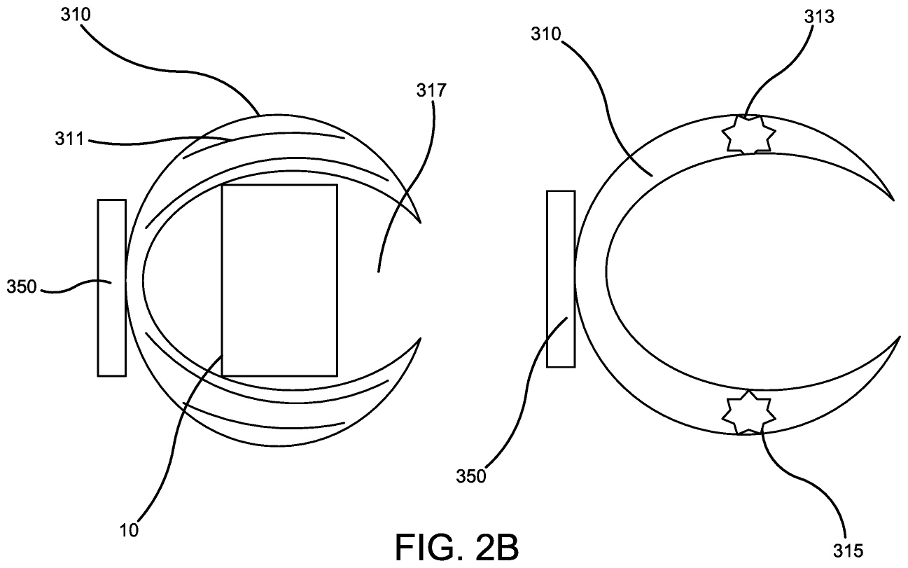

As shown in FIG. 2A, the device 300 is hook shaped and in one embodiment has three main parts. The interior or first leg 350 is the shorter of the two legs. The connector or top portion 330 holds the exterior or second leg 360 and the interior leg 350 together and maintains the spacing of the first and second legs apart depending on the chosen configuration of the sliding component 340 by the user due to the width of the rim of the container. Each of the interior and exterior legs is disposed perpendicularly to the top portion 330. The exterior or second leg 360 is the longer of the two legs and is the leg that houses the external storage hook 50 that is designed to hold painting or other accessories such as, but not limited to, a drip rag, scraper, opener, putty knife, cell phone or other items that an individual using the invention may require. The interior or first leg 350 is the leg that houses the clamp arms 310 to store a variety of shapes and sizes of tools, applicators, or paint brushes 10.

In one embodiment, the hook shaped tool, accessory, or brush holder 300 has dimensions that are designed in accordance with the dimensions of a one-gallon paint can 10. The painting accessory may have an inverted “J” or “L” shape. The exterior leg 360 is designed to be between 2 to about 4 inches long and the interior leg is designed to be about 1 to about 2.5 inches long. The connector 330 between the two legs is designed to be about 0.5 to about 1.5 inches so that it securely attaches to a variety of widths of can rim 26 sizes. The sliding component 340 of the top connector 330 slides to allow the device to adjust to the size of different cans, containers, or receptacles. The first and second legs remain separated from one another by an amount approximately equal to the distance of the top or central connecting portion. The first and second legs do not need to have the same width or thickness. The width of the interior leg ranges from about 0.25 inches to about 2 inches and the width of the exterior leg ranges from about 0.50 inch to 3 inches. Generally, the device 300 can be configured in any other suitable shape as is known in the art, and it can be configured in another suitable size or shape as is known in the art, depending on the needs and/or wants of a user. By providing a wider exterior leg, additional support is provided to prevent the device from moving around the exterior of the can. In addition, an anti-slip material may be provided on the interior of the exterior leg so that it grips to the exterior surface of the can and does not move. The anti-slip material may be rubberized spots or strips.

In one embodiment, the hook shaped painting accessory or brush holder 300 could be composed of various rigid or semi-rigid materials or may be made from two different materials: metal or plastic. The tool or brush holding device may have a metal center skeletal structure with a hard plastic coating. The base skeletal structure is designed to be made of a metal such as aluminum, galvanized steel, stainless steel, other rigid non-rusting material or combinations thereof. In other embodiments, the hook may be made from a hard plastic material to reduce manufacturing costs of the invention. The hook may be protected with a plastic covering. This plastic or other covering will be made of manufactured Polyethylene Terephthalate, High-Density Polyethylene, Low-Density Polyethylene, silicone, or rubber material. The thickness of the protective coating ranges from about 0.25 mils to 2 mils with about 1 mil being preferred. The paint brush storage device can be configured from a plurality of material combinations as is known in the art, depending on the preferences of a user.

Further, the interior leg 350 of the paintbrush holding device 300 includes two clamp arms 310 that are responsible for holding the tool, accessory, applicator, or paint brush 10 in place. These clamp arms 310 can be adjusted to accommodate the different shapes and sizes of paint brush handles 12 which are removed through an opening 317 (see FIG. 2B). These clamp arms can be manufactured from a material such as a bendable plastic like Low-Density Polyethylene. The clamp arms 310 can be configured to fit a variety of handle shapes such as circular, square, hexagonal handles, etc. The clamp arms 310 can be configured in a variety of different shapes and sizes as known in the art, depending on the needs and wants of the user.

As shown in FIG. 2B, alternate embodiments of the clamp arms 310 are shown. In one embodiment, the clamp arms 310 are provided with a shape memory material 311 embedded in the arms. The memory material 311 may be Nitinol wires which would be embedded in plastic, rubber, or another movable or conformable material so the user, when repeatedly using the same tool or brush, does not need to constantly reshape the arms to hold the tool or brush 10. In another embodiment shown in FIG. 2B the arms 310 are provided with a selectable setting by turning or opening the arms along axis points 313 and 315. In this way, the arms can be easily opened and closed around the tool or brush 10 to hold the item within the arms.

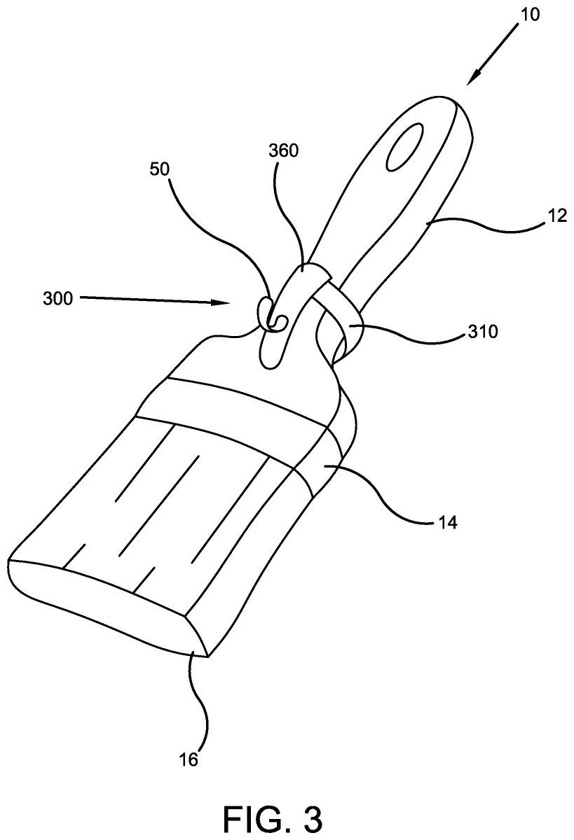

As shown in FIG. 3, the brush hook 300 connects directly to the handle 12 of the tool, such as a paint brush 10, via the adjustable arms 310 that wrap substantially around the handle 12. The holder device connects to the handle so that the exterior leg 360 runs parallel to the interior leg 350 and the tool or paint brush 10. The adjustable clamp arms wrap securely around the handle of the tool or paint brush 10 in an upright position so that the handle 12 is facing directly upward and the work end or plurality of bristles 16 is facing directly downward to maintain the desired configuration of the brush tip. The way the tool or brush is stored will allow any excess paint or other material to drip back into the remaining paint or material in the can, and it will prevent the work end of the tool, such as the bristles of the paint brush 16, from getting bent or permanently damaged.

FIG. 3 also highlights the exterior leg hook 50 that stems from the exterior leg 360 of the tool holder or paint brush storage device 300. The additional hook is designed specifically to support additional paint brushes or painting accessories on the exterior of the paint can but in close proximity to the user for easy access. Such painting accessories may include, but are not limited to, a drip rag, putty knife, scraper, paint can opener, as well as non-painting accessories such as, a cell phone which may be placed within a holder or pocket and then suspended from the hook.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “tool storage device”, “tool, accessory, applicator or brush hook”, and “device” are interchangeable and refer to the tool, applicator, or paint brush holder 300 of the present invention.

Notwithstanding the foregoing, the tool holder or paint brush storage device 300 of the present invention can be of any suitable size and configuration as is known in the art without affecting the overall concept of the invention, provided that it accomplishes the above-stated objectives. One of ordinary skill in the art will appreciate that tool holder or the paint brush storage device 300 as shown in FIGS. 1-3 are for illustrative purposes only, and that many other sizes and shapes of the tool holder or paint brush storage device 300 are well within the scope of the present disclosure. Although the dimensions of the tool holder or paint brush storage 300 are important design parameters for user convenience, the tool holder or paint brush storage device 300 may be of any size that ensures optimal performance during use and/or that suits the user's needs and/or preferences. All dimensions are inclusive.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such a term is intended to be inclusive in a manner similar to the term “comprising” as “comprising” is interpreted when employed as a transitional word in a claim.

1. A tool holder comprising:
a first leg having a first length;
a second leg having a second length that is longer than the first length;
a connector portion having a third length that is distinct from the first length and the second length; and
a pair of arms extending outwardly from the first leg and the connector, wherein the pair of arms are repositionable to grasp a tool.

2. The tool holder as recited in claim 1, wherein the tool is one of a paint brush, a hand tool or an applicator.

3. The tool holder as recited in claim 1, wherein the second leg comprises a hook.

4. The tool holder as recited in claim 1, wherein the first leg and the second leg are spaced apart from one another by the third length.

5. The tool holder as recited in claim 1, wherein the third length is adjustable.

6. The tool holder as recited in claim 1, wherein the pair of arms are comprised of a shape memory material.

7. The tool holder as recited in claim 6, wherein the shape memory material is Nitinol.

8. The tool holder as recited in claim 1, wherein the third length is between 0.5 and 1.5 inches.

9. The tool holder as recited in claim 1, wherein the first leg has a width that ranges from 0.25 inches to 2 inches, and the second leg has a width that ranges from 0.50 to 3 inches.

10. The tool holder as recited in claim 1, wherein the second length is between 2 and 4 inches, and the first length is between 1 to about 2.5 inches.

11. The tool holder as recited in claim 1 further comprising an anti-slip material positioned on an interior surface of the second leg.

12. The tool holder as recited in claim 1 further comprising a metal core and a protective coating.

13. The tool holder as recited in claim 12, wherein the protective coating is one of a Polyethylene Terephthalate, a High-Density Polyethylene, a Low-Density Polyethylene, a silicone, or a rubber material.

14. A paint can and paint brush holder combination comprising:
a paint can comprised of a base, an interior wall, an exterior wall and a rim;
a paint brush holder comprised of an interior leg, and exterior leg and a center portion connecting the interior leg to the exterior leg and spacing the interior leg and exterior leg a length equal to a length of the center portion; and
a pair of arms extending outwardly from the interior leg and the center portion, wherein the pair of arms are repositionable to accommodate a paint brush, and further wherein the center portion is adjustable to fit on the rim of the paint can.

15. The paint can and paint brush holder combination as recited in claim 14, wherein the interior leg has a first length and the exterior leg has a second length that is longer than the first length.

16. The paint can and paint brush holder combination as recited in claim 14, wherein the paint brush is held by the pair of arms so that a plurality of bristles of the paint brush extend toward the base of the paint can.

17. The paint can and paint brush holder combination as recited in claim 14, wherein the pair of arms are comprised of a shape memory material.

18. The paint can and paint brush holder combination as recited in claim 14, wherein the length of the center portion is between 0.5 and 1.5 inches.

19. The paint can and paint brush holder combination as recited in claim 14 further comprising a protective covering that is positioned over an aluminum, a galvanized steel, a stainless steel, a rigid non-rusting material or a combination thereof.

20. A paint brush storage device comprising:
an interior leg having a length of 1 to 2.5 inches and a width of 0.25 inches to 2 inches;
an exterior leg having a length of 2 to 4 inches and a width of 0.50 to 3 inches;
a connector having a length of 0.5 to 1.5 inches, wherein the interior and exterior legs are spaced apart a distance that is equal to the length of the connector, and further wherein the connector is adjustable to fit on a rim of a paint can; and
a pair of gripping arms extending outwardly from the connector and the interior leg, wherein the pair of gripping arms are repositionable to grasp a paint brush such that a plurality of bristles of the paint brush are facing downward relative to the connector.
